(19) United States
(12) Patent Application Publication
(10) Pub. No.: US 2007/0063929 A1
(43) Pub. Date: Mar. 22, 2007

(54) Plasma display panel driving and a method of driving the same

(76) Inventors: Ki Rack Park, Chilgok-gun (KR); Doo Yong Hwang, Yongin-si (KR)

Correspondence Address: FLESHNER & KIM, LLP, P.O. BOX 221200, CHANTILLY, VA, 20153, US

(21) Appl. No.: 11/524,910

(22) Filed: Sep. 22, 2006

(30) Foreign Application Priority Data
Sep. 22, 2005 (KR) 10-2005-0088295

(51) Int. Cl. G09G 3/28

(52) U.S. Cl. 345/67

(57) ABSTRACT

A plasma display apparatus includes an address driver for applying a predetermined waveform to an address electrode so that the predetermined waveform overlaps a sustain pulse applied to a scan electrode or a sustain electrode during a sustain period. As a result, it is possible in accordance with at least one embodiment to improve image quality by preventing erroneous discharge that may occur after the start of a sustain period.

### BACKGROUND

1. Field

One or more embodiments described herein relate to display devices.

2. Background

In recent years, flat panel displays such as liquid crystal displays (LCD), field emission displays (FED), plasma display panels (PDPs), and the like have been actively developed. The PDP has proven to be desirable because it offers high luminance, high luminous efficiency, and wide viewing angle.

A PDP is a flat panel display that uses plasma generated by a gas discharge to display characters or images. Based on its size, a PDP can have several scores to millions of pixels arranged in a matrix pattern. PDPs are classified as a direct current (DC) type or an alternating-current (AC) type depending on the discharge cell structure and the waveform of the driving voltage applied thereto.

A DC-type PDP has electrodes which are exposed to a discharge space to allow direct current to flow through the discharge space while voltage is applied. A panel of this type requires a resistance for limiting the current.

An AC-type PDP has electrodes covered with a dielectric layer that forms a capacitance component that limits the current. This layer also protects the electrodes from the impact of ions during a discharge. Such a panel is therefore considered superior to the DC-type PDP in regard its ability to achieve a long lifetime. Improvements, however, are still need for both types of panels.

### BRIEF DESCRIPTION OF THE DRAWINGS

The embodiments of the invention will be described in detail with reference to the following drawings in which like numerals refer to like elements, wherein:

FIG. 1 is a diagram showing one embodiment of a panel structure;

FIG. 2 is a diagram showing one embodiment of a driver circuit in a panel;

FIG. 3 is a diagram showing a signal waveform in accordance with another embodiment for driving a panel;

FIG. 4 is a diagram showing a signal waveform in accordance with another embodiment for driving a panel;

FIG. 5 is a diagram showing a signal waveform in accordance with yet another embodiment for driving a panel;

FIG. 6 is a diagram showing a signal waveform in accordance with yet another embodiment for driving a panel;

FIGS. 7A to 7C are diagrams showing an application time point of an address waveform for one or more embodiments of the panel described herein; and

FIGS. 8A to 8C are diagrams showing an ending time point of an address waveform for one or more embodiments of the panel described herein.

### DETAILED DESCRIPTION

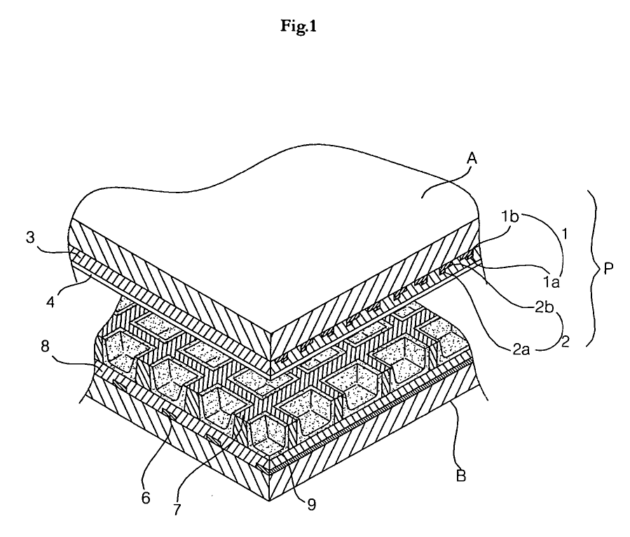

FIG. 1 shows the structure of a plasma display panel P according to one embodiment, where panel P is formed by coupling of a front substrate A to a rear substrate B. A scan electrode 1 and a sustain electrode 2 are formed in the front substrate A and an address electrode 6 is formed in the rear substrate B. The scan electrode, the sustain electrode, and the address electrode 6 intersect within a cell in the panel.

The scan electrode 1 and sustain electrode 2, respectively include transparent electrodes 1b and 2b and bus electrodes 1a and 2a. The transparent electrode may be made of a very small amount of tin oxide and indium oxide (called indium tin oxide (ITO)), and emits light generated within the cell to the outside due to high light transmittance. Furthermore, the scan electrode 1 and sustain electrode 2 respectively include bus electrodes 1a and 2a in order to lower surface resistance of the transparent electrodes.

A dielectric layer 3 is formed on the scan electrode 1 and sustain electrode 2, and a protective film 4 may be formed to protect the dielectric layer 3. Another dielectric layer 8 is formed on the address electrode 6, and a barrier rib 7 for partitioning a discharge cell in a horizontal direction and a vertical direction is formed on the dielectric layer 8. R, G, B phosphors 9 are coated on the dielectric layer 8 and rib 7.

One possible dielectric material used to form the substrate, barrier rib, and dielectric layer is PbO—SiO₂—B₂O₃. If such a material is used, substrates A and B, barrier rib 7, and/or dielectric layers 3 and 8 containing Pb less than 1000 ppm or a Pb-less (Pb is not applied) may be used in order to prevent environmental contamination while lowering a firing temperature. In accordance with another embodiment, the substrates A and B, barrier rib 7, and/or dielectric layers may also be composed of SiO₂, B₂O₃, Al₂O₃, BaO, or Li₂O.

Other embodiments of the plasma display panel are not limited to the substrate shown in FIG. 1. For example, the scan electrode and sustain electrode may be an ITO-less structure including, for example, only bus electrodes 1a and 2a without including transparent electrodes 1b and 2b that are made of ITO. The scan and sustain electrodes may also have a structure in which a black matrix BM is integrally formed in the front substrate A. According to another embodiment, the scan electrode and sustain electrode may include at least two electrode lines and other electrodes may also be included.

In FIG. 1, a barrier rib structure formed in the rear substrate B may be a close type, which is a structure for closing a discharge cell, but the embodiments described herein are not limited to this structure. For example, the structure may alternatively be a stripe type, which is a structure in which a barrier rib of any one direction is omitted, or a fish bone type in which a protrusion is formed with a predetermined interval on a vertical barrier rib 7.

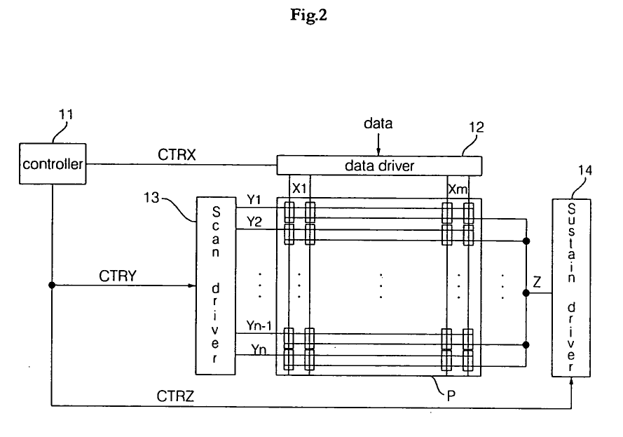

FIG. 2 shows a data driver 12, a scan driver 13, and a sustain driver 14 for applying a driving signal to an electrode formed in the panel P. The data driver 12 may supply data to address electrodes X1 to Xm in the panel, the scan driver 13 may be used to drive scan electrodes Y1 to Yn, and sustain driver 14 maybe used to drive a sustain electrode Z. A controller 11 is also included for controlling switching timing in each of the drivers 12, 13, and 14. The data driver 12 may be used to supply a data pulse for selecting on-cell and off-cell to the address electrodes X1 to Xm.

While FIG. 2 shows panel driving circuits that perform in a single-scan manner for address electrodes X1 to Xm that are not divided, it is noted that the embodiments described herein are not intended to be limited to this structure. For example, the address electrodes may alternatively be divided into at least two groups to drive in a dual-scan manner for applying a driving signal to first scan electrode lines Y1 to Ym and second scan electrode lines Yn-m to Yn, intersecting each of the divided address electrode groups.

Furthermore, a structure may be used in which the address electrodes X1 to Xm are divided into an odd numbered address electrode (X1, X3, . . . , Xm-1) group and an even numbered address electrode (X2, X4, . . . , Xm) group. In this arrangement, at least two data drivers may be used for applying a driving signal to each group.

The scan driver 13 may supply a setup signal PR which gradually rises and a setdown signal NR which gradually falls during a reset period RP, and may sequentially supply scan pulses to scan electrodes Y1 to Yn to select a scan line to which data are supplied during an address period AP. A sustain pulse may also be supplied during a sustain period SP to maintain a discharge within the selected on-cells, under the control of the controller 11. The sustain driver 14 may supply a sustain pulse to the sustain electrode by alternately operating with the scan driver 13 during a sustain period SP.

Furthermore, the controller 11 may receive vertical and horizontal synchronous signals and a clock signal, may generate timing control signals CTRX, CTRY, and CTRZ required for drivers 12, 13, and 14, and may supply the timing control signals CTRX, CTRY, and CTRZ to corresponding drivers, thereby controlling each of the drivers.

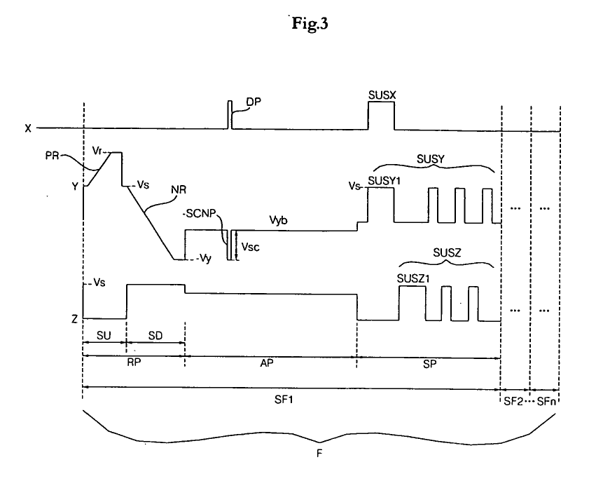

FIG. 3 shows a signal waveform according to a first embodiment which may be supplied during one subfield by drivers 12, 13, and 14. The waveform may be described relative to a reset period, an address period, and a sustain period.

The reset period RP is a period in which a setup signal and a setdown signal may be applied, so as to initialize discharge cells of an entire screen. The address period AP is a period in which a data pulse is applied to the address electrode while the scan pulse is applied to the scan electrode to select a discharge cell. The sustain period SP is a period of alternately applying a sustain pulse to the scan electrode and the sustain electrode to maintain a discharge within the selected discharge cell.

During a setup period SU within the reset period RP, a setup signal PR which gradually rises up to a reset voltage Vr is applied to all scan electrodes Y. As a setup discharge is generated by the setup signal PR, wall charges are slowly accumulated at the inside thereof.

During a setdown period SD, a setdown signal NR which gradually falls to a negative erase voltage is applied to the scan electrode to erase excessive wall charges unnecessary for performing an address discharge within the discharge cell. At the same time, a positive voltage is applied to the sustain electrode Z.

During an address period AP, a negative scan pulse (−SCNP) falling from a scan bias voltage Vyb to a negative scan voltage (−Vy) is sequentially applied to the scan electrode and a positive data pulse DP is simultaneously applied to the address electrode X. At this time, a positive bias voltage is supplied to the sustain electrode Z. Therefore, during an address period AP, an address discharge is generated based on a voltage difference between the scan pulse (−SCNP) and the data pulse DP and thus a discharge cell is selected.

During a sustain period SP, sustain pulses SUSY and SUSZ each preferably having a positive sustain voltage Vs are alternately applied to the scan electrode Y and sustain electrode Z. As a result, a voltage difference between the scan and sustain electrodes becomes larger than a discharge firing voltage, thereby generating a surface-discharge scheme sustain discharge.

The address driver according to the foregoing embodiment may apply a waveform SUSX having a positive voltage level to the address electrode X during a sustain period SP and the waveform has a voltage level between a low potential voltage level and a high potential voltage level of a sustain pulse. A voltage difference between electrodes (X-Z electrodes and X-Z electrodes) opposite to each other therefore decreases and thus an undesired opposing discharge may not be generated during a sustain period SP.

In the embodiment shown in FIG. 3, as a sustain period SP starts, a first sustain pulse SUSY1 applied to the scan electrode Y is formed to have a pulse width longer than one or more, or even all, of the remaining sustain pulses to stably accumulate wall charges. As a result, a surface discharge is also stably generated between the scan electrode Y and the sustain electrode Z.

A waveform SUSX having a positive voltage level is applied to the address electrode X, so that the waveform SUSX overlaps the first sustain pulse SUSY1 by the address driver according to this embodiment.

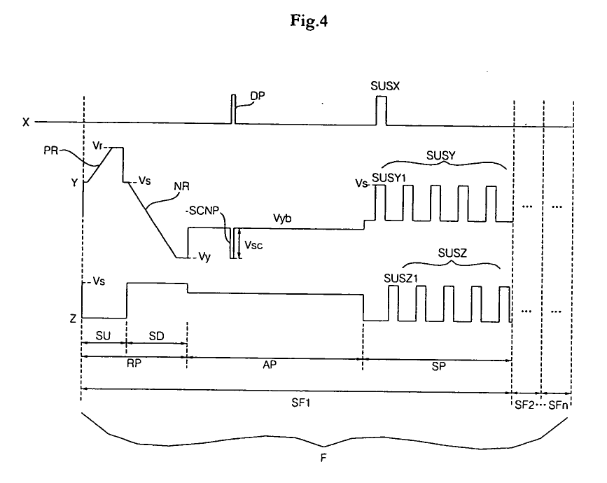

FIG. 4 shows a signal waveform according to a second embodiment. Unlike the first embodiment, in the second embodiment, as a sustain period SP starts, a width of a first sustain pulse SUSY1 applied to the scan electrode Y and a first pulse SUSZ1 applied to the sustain electrode Z is formed to be equal to the remaining sustain widths. A waveform SUSX having a positive voltage level is applied to the address electrode X, so that the waveform SUSX overlaps the first sustain pulse by the address driver.

Accordingly, in the second embodiment, because a voltage difference decreases between the scan electrode Y and the address electrode X to which the first sustain pulse SUSY1 is applied, an undesired opposing discharge may be prevented and the problem of gray scale expression deterioration by the opposing discharge may be improved.

The driving waveform shown in FIG. 3 can be deformed or modified in various ways. For example, a reset period RP may be omitted in at least one subfield of a plurality subfields constituting one frame, or a reset period may exist only in a first subfield.

Furthermore, before a reset period of a next subfield starts after a sustain period of any one subfield ends, an erase pulse for allowing a state of wall charges within the discharge cell to be uniform can be additionally applied. In addition, the sustain pulses may be applied to the sustain electrodes and the scan electrodes not only alternately but also (or alternatively) concurrently. For example, according to one variation, while Vs/2 is applied to the scan electrode, −Vs/2 may be substantially and concurrently applied to the sustain electrode (herein, Vs is referred to as a voltage sufficient to make a discharge or emit light during the sustain period). As a result, the discharge cell would perceive or function as if Vs is applied during the sustain electrode and therefore sustain discharge can occur during the sustain period.

In addition, for simplicity, in FIGS. 3 and 4, the setup signal PR and the setdown signal NR appear just one time. However, practically, during the reset period, the setup signal PR and the setdown NR may appear more than one time, for example, 2 or 3 times to initialize the discharge cell.

In FIGS. 3 and 4, the voltage level of Vr may be, for example, in a range from 280V to 480V for an effective initialization during the setup period. The voltage level of −Vy may be in a range from −170V to −280V for an effective initialization during the setdown period. The voltage level of the Vsc may be from −175V to 290V for an effective addressing process during the address period. The voltage difference between the −Vy and the Vsc may be from 5V to 10V to utilize the charges in the cell. And, the voltage level of the sustain pulse SUSX and/or SUSZ may be from 70V to 350V to effective sustain the light emitted from the discharge cells. Other values are also possible.

During a sustain period SP, other size signals that can cause a sustain discharge, in addition to those shown in the waveform, may be applied. Because a voltage difference between the scan electrode and sustain electrode exceeds a discharge firing voltage that causes a sustain discharge, a sustain voltage Vs and a ground voltage (e.g., OV), or a half sustain voltage Vs/2 and a negative half sustain voltage (−Vs/2), may be applied to each electrode. A positive sustain voltage Vs may be applied to only one electrode, and a negative sustain voltage (−Vs) may be sequentially applied to other electrodes.

In FIG. 4, a start voltage of a setup signal and a start voltage of a setdown signal are shown as being substantially the same voltage level. In the alternative embodiment, a start voltage level of the setup signal may be higher than or lower than a start voltage level of the setdown signal.

The setup signal or the setdown signal are waveforms that gradually rise or fall, and therefore have at least two slopes. In some embodiments, these signals may rise or fall in steps. These signals may further assist in providing enough formation of wall charges as a pre-reset period exists before a reset period in at least one of a plurality subfields constituting one frame.

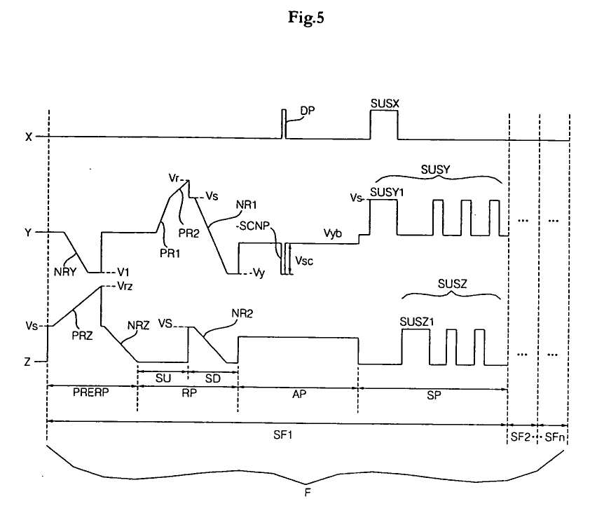

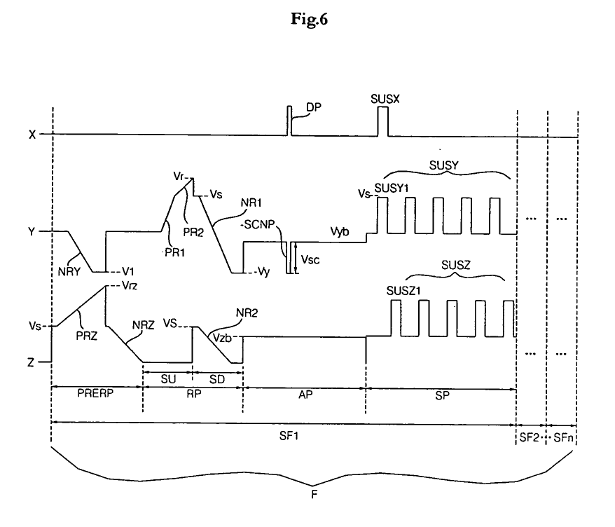

For example, during a pre-reset period, a reset discharge can be previously generated by applying a positive voltage to the sustain electrode, while a signal having a voltage value that gradually decreases may be applied to the scan electrode. However, the pre-reset period may exist only in a first subfield when a driving margin is taken into consideration. This will be described with reference to FIGS. 5 and 6.

During the pre-reset period PRERP of FIG. 5, a ramp waveform PRZ which gradually rises up to a positive reset voltage Vrz is applied to the sustain electrode Z, and a ramp waveform NRY which gradually falls down to a negative voltage (−V1) is applied to the scan electrode Y. During the pre-reset period PRERP, formation of wall charges to be formed during a next reset period RP can be assisted, due to a voltage difference between the scan electrode Y and the sustain electrode Z.

During a setup period SU of the reset period RP, a first ramp waveform PR1 which gradually rises with a first slope and a second ramp waveform PR2 which rises with a second slope are continuously applied to the scan electrode Y. The first and second slopes may be equal, but it is preferable that the second slope is smoother or more gradual than the first slope. This is because deterioration of contrast characteristics is prevented due to a strong discharge, generated as a voltage of a scan electrode sharply rises during the setup period SU.

Waveforms shown in FIGS. 5 and 6 are different from those of embodiments shown in FIGS. 3 and 4 during a pre-reset period PRERP and a reset period RP. Specifically, a driving time of a discharge cell is shortened due to wall charges formed during the pre-reset period and a ramp waveform rises with at least two slopes during a setup period. This waveform may be referred to as an extremely time reduced waveform XTR.

Even in the XTR waveform shown in FIG. 5, the first sustain pulse SUSY1 applied during a sustain period SP has a pulse width longer than the remaining sustain pulses. Also, a waveform SUSX having a positive voltage level is applied to the address electrode X so that the waveform SUSX overlaps the first sustain pulse SUSY1 by the address driver. This is referred to as a third embodiment.

Furthermore, even in the XTR waveform shown in FIG. 6, a width of the first sustain pulse SUSY1 applied during a sustain period SP may be formed to be equal to widths of one or more, or even all of, the remaining sustain pulses. Also, a waveform SUSX having a positive voltage level is applied to the address electrode X by the address driver. This is referred to as a fourth embodiment.

Thus, in the third and fourth embodiments, the waveform SUSX having a positive voltage level is applied to the address electrode X so that it overlaps with the first sustain pulse SUSY1. As a result, a voltage difference between the scan electrode Y and the address electrode X can be reduced, and deterioration of image quality may therefore be prevented due to an undesired opposing discharge.

In addition, as described above, the sustain pulses applied to the sustain electrodes and the scan electrodes may be applied not only alternately but also (or alternatively) concurrently. For example, while Vs/2 is being applied to the scan electrode, the −Vs/2 would be substantially and concurrently applied to the sustain electrode. As a result, the discharge cell would perceive or function as if Vs is applied during the sustain electrode, and therefore sustain discharge can occur during the sustain period.

In addition, for simplicity, in FIGS. 5 and 6, the setup signal PR and the setdown signal NR appear just one time respectively. However, in alternative embodiments, during the reset period, the setup signal PR and the setdown signal NR may appear more than one time, for example 2 or 3 times to initialize the discharge cell.

In FIGS. 5 and 6, the voltage level of Vr may, for example, be from 280V to 480V for an effective initialization during the setup period. The voltage level of −Vy may, for example, be in a range from −170V to −280V for an effective initialization during the setdown period. And, the voltage level of the Vsc may, for example, be from −175V to 290V for an effective addressing process during the address period.

Also, in the embodiments described herein, the voltage difference between the −Vy and the Vsc may, for example, be from 5V to 10V to utilize the charges in the cell. And, the voltage level of the sustain pulses SUSX SUSZ may, for example, be from 70V to 350V to effective sustain light emitted from the discharge cells. Other values are also possible.

In addition, for simplicity, in the third and forth embodiments, the setup signals PR1 and PR2 and the setdown signal NR1 are shown as appearing just one time. However, in alternative embodiments, during the reset period, the setup signals PR1 and PR2 and the setdown signal NR1 may appear more than one time, for example 2 or 3 times, to initialize the discharge cell.

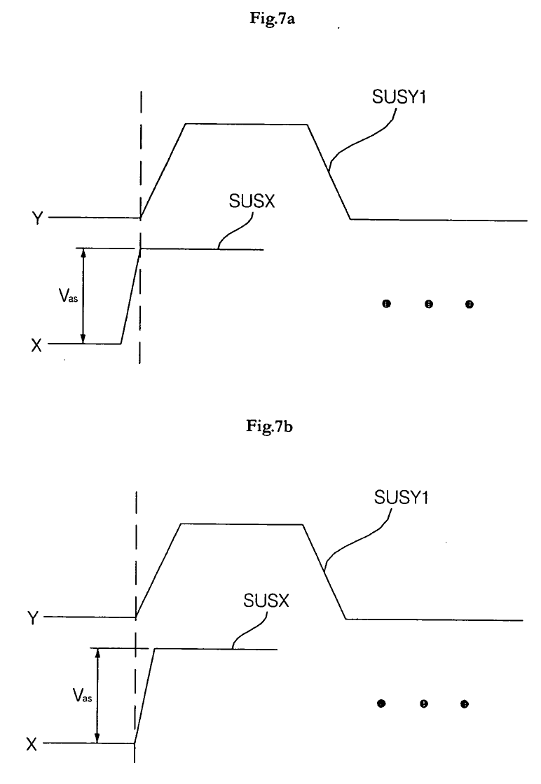

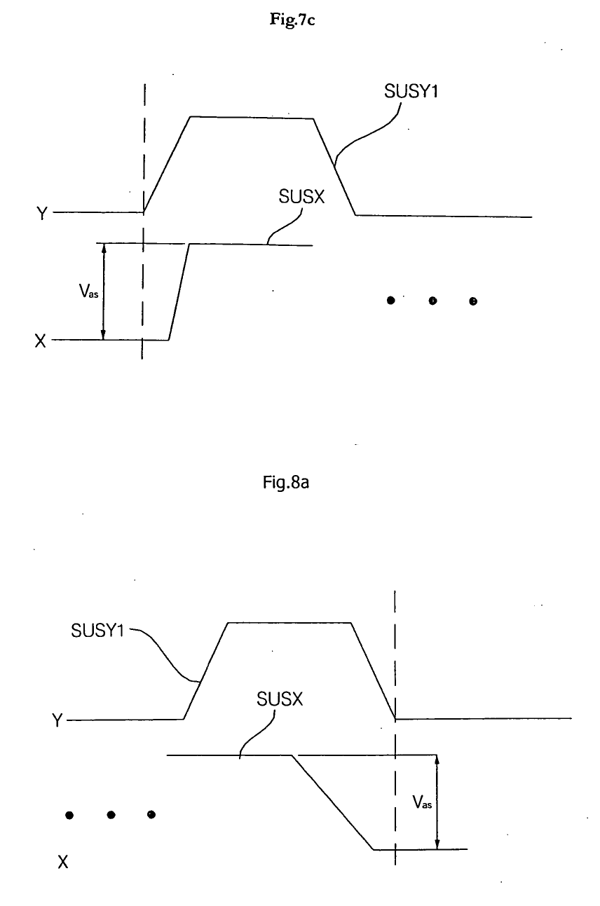

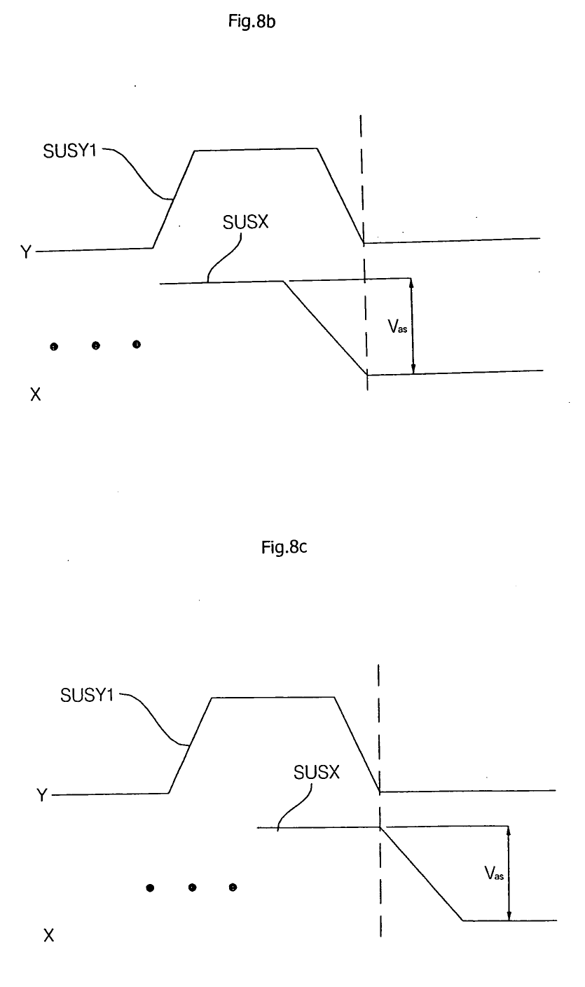

In the first to fourth embodiments, a waveform applied to address electrode X may overlap with a sustain pulse by changing an applying time point and an ending time point thereof, as shown in FIGS. 7 and 8.

FIGS. 7A to 7C show applying time points of the waveform SUSX for different embodiments. In FIG. 7A, a voltage difference between the address electrode and the scan electrode is reduced by applying a waveform to the address electrode X earlier than the first sustain pulse SUSY1 applied to the scan electrode Y. This may prevent erroneous discharge.

In FIG. 7B, the waveform SUSX is applied at the same time point as an application time point of the first sustain pulse SUSY1 applied to the scan electrode Y. And, in FIG. 7C, the waveform SUSX is applied after the sustain pulse SUSY1.

The rising time of the pulse applied to the address electrode during the sustain period may, for example, be from 50 to 800 nanoseconds. The maintaining time of the pulse applied to the address electrode during the sustain period may be from 300 nanosecond to 400 microseconds. And, the falling time of the pulse applied to the address electrode during the sustain period may be from 50 to 800 nanoseconds. Other values are also possible. In FIGS. 7A-7C, the rising time of the pulse may be regarded as the time taken from the lowest level or ground level to the highest level of the pulse, thereby defining a shape of the pulse.

The rising time of the pulse applied to the sustain or scan electrode during the sustain period may, for example, be from 100 to 1300 microseconds. The maintaining time of the pulse applied to the sustain or scan electrode during the sustain period may be from 500 to 2800 microseconds. And, the falling time of the pulse applied to the address electrode during the sustain period may be from 100 to 1300 microseconds. Other values are also possible. The rising time of the pulse referred to in FIGS. 7A-7C may be regarded as the time taken from the lowest level or ground level to highest level of the pulse, thereby defining a shape of the pulse.

Also, in FIGS. 7A-7C, the period when the pulse applied to the address electrode SUSX overlaps with the sustain pulse SUSY1 may be from 100 microseconds to 400 microseconds. In addition, 50% to 100% of the pulse applied to the sustain or scan electrode during the sustain period may overlap with the pulse applied to the address electrode during the sustain period.

That is, assuming that a period of the waveform SUSX overlaps sustain pulse SUSY1 when SUSY1 maintains a high potential voltage level, the waveform SUSX can be applied to the address electrode X earlier than, at the same time with, or later than the sustain pulse SUSY1.

FIGS. 8A-8C show an ending time point of the waveform SUSX. As shown in FIG. 8A, the waveform SUSX applied to the address electrode X may end earlier than the first sustain pulse SUSY1 applied to the scan electrode Y. As shown in FIG. 8B, ending time points of the two waveforms may be equal. And, as shown in FIG. 8C, the waveform SUSX may end later than an ending time point of the first sustain pulse SUSY1.

The rising time of the pulse applied to the address electrode during the sustain period may, for example, be from 50 to 800 nanoseconds. The maintaining time of the pulse applied to the address electrode during the sustain period may be from 300 nanosecond to 400 microseconds. And, the falling time of the pulse applied to the address electrode during the sustain period may be from 50 to 800 nanoseconds. Other values are also possible. The rising time of the pulse can be regarded as the time taken from the lowest level or ground level to highest level of the pulse. The falling time of the pulse may be regarding as the time taken from the highest level of the pulse to the lowest level or ground level.

The rising time of the pulse applied to the sustain or scan electrode during the sustain period may, for example, be from 100 to 1300 microseconds. The maintaining time of the pulse applied to the sustain or scan electrode during the sustain period may be from 500 to 2800 microseconds. And, the falling time of the pulse applied to the address electrode during the sustain period may be from 100 to 1300 microseconds. Other values are also possible. The rising time of the pulse may be regarded as the time taken from the lowest level or ground level to highest level of the pulse. The falling time of the pulse may be regarding as the time taken from the highest level of the pulse to the lowest level or ground level.

Thus, in FIGS. 8a-8c, the period when the pulse applied to the address electrode SUSX overlaps with the sustain pulse SUSY1 may be from 100 microseconds to 400 microseconds. In addition, 50% to 100% of the pulse applied to the sustain or scan electrode during the sustain period may overlap with the pulse applied to the address electrode during the sustain period. A predetermined waveform SUSX applied to the address electrode X may be applied to overlap with the first sustain pulse SUSY1 and may be applied to overlap with a plurality of sustain pulses applied after the first sustain pulse SUSY1.

Furthermore, a predetermined waveform SUSX applied to the address electrode X may be applied during at least one subfield constituting or included in one frame, and is preferably applied during a first subfield (initial subfield, SF1) expressing a low gray scale.

A predetermined waveform applied to the address electrode is preferably applied to overlap not only with the first sustain pulse SUSY1, and may be applied to overlap with the sustain pulse for a predetermined time right after the first sustain pulse is applied or for a time when five or less sustain pulses are applied.

This is because an exposure of light sensitively stimulates a user's sight due to an undesired opposing discharge in an initial subfield expressing a low gray scale suitable for an dark image. A small waveform having a positive voltage level may be applied to the address electrode, particularly, during an initial subfield or during a time right after a sustain period starts. As a result, an erroneous discharge may be prevented during a sustain period.

A range of a voltage level Vas of a waveform applied to the address electrode X may be determined by a voltage applied to the scan electrode Y and the sustain electrode Z. The applied waveform may have various forms such as a square wave, a triangle wave, or a ramp wave.

For example, the predetermined waveform SUSX may be applied to the address electrode to reduce a voltage difference between the first electrode (scan electrode or sustain electrode) and the address electrode, and a low potential voltage level may be higher than a low potential sustain voltage and a high potential voltage level may be equal to or less than a high potential sustain voltage. Accordingly, as a voltage difference between the first electrode and the address electrode X has the relationship of 0<voltage difference<sustain voltage Vs, it has a value less than that of a discharge firing voltage, whereby an opposing discharge is not generated.

It is preferable that a voltage level Vas of a waveform that applies to the address electrode X is equal to that of a data pulse applied during an address period. This is because a data pulse may be applied during an address period using an external DC power source in a circuit construction having an address driver. As the external DC power source is shared so as to apply the waveform during a sustain period, a circuit can be formed without an additional external power source.

The external DC power source may have a voltage value of about 60V to 70V, but can be differently set depending on a panel size, a size of a discharge cell, and/or development of a driving technology.

Furthermore, as mentioned above, it is preferable that a rising time of a waveform SUSX applied to the address electrode X is shorter than an ER rising time of sustain pulses SUSY or SUSZ by an energy recovery circuit of a scan driver or a sustain driver for supplying a sustain pulse.

A plasma display apparatus according to one or more embodiments may, therefore, include an address driver for applying a waveform having a positive voltage level to an address electrode so that the waveform overlaps with a sustain pulse applied to a scan electrode or a sustain electrode during a sustain period.

A waveform applied to the address electrode is applied so that the waveform overlaps with a first sustain pulse SUSY1 applied to the scan electrode or the sustain electrode and the waveform may be applied earlier than, at the same time with, and later than an applying time point of the first sustain pulse.

Similarly, a waveform applied to the address electrode may be ended earlier than, at the same time with, and later than an ending time point of a first sustain pulse applied to the scan electrode or the sustain electrode.

That is, since an applying time point and an end time point of a waveform applied to the address electrode during a sustain period are determined so that the waveform overlaps with a part or all of the first sustain pulse, a voltage difference between the address electrode and the scan electrode or the sustain electrode opposite thereto decreases.

Furthermore, a waveform applied to the address electrode during the sustain period is one of a square wave, a triangle wave, and a ramp wave, and a highest voltage level of the waveform is higher than a low potential voltage level of a sustain pulse and is equal to or lower than a high potential voltage level.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A plasma display apparatus comprising.
an address driver for applying a predetermined waveform having a predetermined voltage level to an address electrode, wherein the predetermined waveform overlaps with a sustain pulse applied to a scan electrode or a sustain electrode during a sustain period of at least one subfield.

2. The plasma display apparatus of claim 1, wherein the predetermined waveform overlaps with a first sustain pulse that is first applied to one of the scan electrode and the sustain electrode.

3. The plasma display apparatus of claim 2, wherein a width of the first sustain pulse is longer than one or more remaining sustain pulses in the at least one subfield.

4. The plasma display apparatus of claim 1, wherein the predetermined waveform is applied during a sustain period of a first subfield expressing a low gray level.

5. The plasma display apparatus of claim 1, wherein the predetermined waveform is one of a square wave, a triangle wave, or a ramp wave.

6. The plasma display apparatus of claim 1, wherein the predetermined voltage level is a positive voltage level.

7. The plasma display apparatus of claim 6, wherein the positive voltage level is higher than a low voltage level of the sustain pulse and is substantially equal to or lower than a high voltage level of the sustain pulse.

8. The plasma display apparatus of claim 6, wherein the positive voltage level corresponds to a highest voltage level of a data pulse applied to the address electrode during an address period.

9. The plasma display apparatus of claim 1, wherein the predetermined waveform is applied earlier than an application time point of the sustain pulse.

10. The plasma display apparatus of claim 1, wherein the predetermined waveform is simultaneously applied with the sustain pulse.

11. The plasma display apparatus of claim 1, wherein the predetermined waveform is applied later than an application time point of the sustain pulse and is applied before a period maintaining a high level of the sustain pulse ends.

12. The plasma display apparatus of claim 1, wherein the predetermined waveform has a rising time shorter than a rising time of the sustain pulse.

13. A plasma display apparatus comprising:
a first electrode to which a sustain pulse is applied during a sustain period of at least one subfield of one frame;
a second electrode to which a data pulse is applied during an address period; and
an address driver for applying a waveform having a predetermined voltage level to the second electrode so that a voltage difference between the first electrode and the second electrode is less than a discharge firing voltage during a sustain period.

14. The plasma display apparatus of claim 13, wherein a waveform applied to the second electrode overlaps with part or all of the first sustain pulse applied to the first electrode during the sustain period.

15. The plasma display apparatus of claim 13, wherein the predetermined voltage level is a positive voltage level.

16. A driving method of a plasma display apparatus comprising:
applying a sustain pulse to a first electrode during a sustain period of at least one subfield; and
applying a predetermined waveform having a predetermined voltage level to a second electrode opposite to the first electrode, wherein the predetermined waveform is applied to overlap with the sustain pulse.

17. The driving method of claim 16, wherein the predetermined waveform is applied to an address electrode and overlaps with part or all of a first sustain pulse after a sustain period starts.

18. The driving method of claim 17, wherein a width of the first sustain pulse is longer than a width of one or more remaining sustain pulses applied during the sustain period of the at least one subfield.

19. The driving method of claim 17, wherein a width of the first sustain pulse is substantially equal to a width of one or more remaining sustain pulses applied during the sustain period of the at least one subfield.

20. The driving method of claim 16, wherein the predetermined waveform applied to the second electrode is one of a square wave, a triangle wave, or a ramp wave.

21. The driving method of claim 16, wherein the predetermined voltage level is a positive voltage level.

22. The driving method of claim 21, wherein the positive voltage level of the predetermined waveform is higher than a low voltage level of the sustain pulse and is substantially equal to or lower than a high voltage level of the sustain pulse.
